(19) United States
(12) Patent Application Publication
(10) Pub. No.: US 2024/0424924 A1
(43) Pub. Date: Dec. 26, 2024

(54) Adapter for Fastening to an Energy Store, Energy Store, Coupling Unit, System for Coupling an Energy Store

(71) Applicant: ZF Friedrichshafen AG, Friedrichshafen (DE)

(72) Inventor: Finn Neumann, Blaustein (DE)

(21) Appl. No.: 18/703,437

(22) PCT Filed: Oct. 27, 2022
(86) PCT No.: PCT/EP2022/080095

§ 371 Date: Apr. 22, 2024

(30) Foreign Application Priority Data
Nov. 2, 2021 (DE) 10 2021 212 301.5

(51) Int. Cl. B60L 53/16; H01M 50/249; H01M 50/262; H01M 50/296

(52) U.S. Cl. CPC B60L 53/16; H01M 50/249; H01M 50/262; H01M 50/296; B60L 2200/12; H01M 2220/20

(57) ABSTRACT

A system for coupling an energy store to a normal coupling unit meant for a taller energy store includes an energy store, a normal coupling unit, and an adapter. A coupling profile of the energy store is defined by a recess in the upper side of the energy store and a coupling cam having an engagement surface. The adapter has a fastening portion receivable within the coupling profile of the energy store and is detachably fastened to the energy store. The adapter also has a coupling portion having a coupling structure with a coupling surface and a curved surface. A pivotable lever of the normal coupling unit engages on the coupling surface of the adapter and is guided on the curved surface of the adapter such that pivoting of the lever is transformed into translational movement of the energy store towards the normal coupling unit.

### CROSS-REFERENCE TO RELATED APPLICATION

The present application is related and has right of priority to German Patent Application No. 10 2021 212 301.5 filed on Nov. 2, 2021, and is a nationalization of PCT/EP2022/080095 filed in the European Patent Office on Oct. 27, 2022, both of which are incorporated by reference in their entirety for all purposes.

### FIELD OF THE INVENTION

The present invention relates generally to an adapter for fastening to an energy store. The present invention further related generally to an energy store, to a coupling unit, and to a system for coupling an energy store to a coupling unit.

### BACKGROUND

A battery plays a significant role in micromobility vehicles, for example in electric bicycles, cargo bikes, electric tricycles, etc., with respect to the range of the vehicle to be obtained and also with respect to the weight. The weight of the battery therefore plays a significant role because additional weight reduces the range, however, large capacities of an energy store are obtained only if the battery or the energy store is correspondingly large and thus heavy. In some cases, however, it is desirable to use smaller energy stores because a large range is not necessary and the advantages of the lower weight take precedence. In particular, a lower weight increases the handling of the two-wheeled vehicle and thus results in greater ease of use for the user.

### SUMMARY OF THE INVENTION

Against this background, the object is to reduce the weight of micromobility vehicles and to enable the use of smaller energy stores.

Accordingly, a first example aspect of the invention relates to an adapter for fastening to an energy store of a micromobility vehicle and for coupling the energy store to a coupling unit, wherein the adapter has a fastening portion and a coupling portion. The fastening portion is fastenable to a socket of the energy store. The coupling portion has a coupling structure for forming a cam mechanism with a lever of the coupling unit, where engagement of the lever of the coupling unit is converted, by pivoting into the coupling structure, into a displacement transverse to a direction of pivoting of the lever.

A further example aspect of the invention relates to an energy store for supplying a micromobility vehicle with energy. The energy store has an end side with an electric plug connector for connecting to a coupling unit, and a coupling profile in the region of an upper side of the energy store, having coupling cam with an engagement surface. A lever of a coupling unit engaging in the coupling profile bears against the engagement surface and a pivoting movement of the lever is converted into a displacement of the energy store in a direction normal to the end side. An adapter for adapting the energy store for coupling to a normal coupling unit for normal energy stores with a greater height is detachably fastenable on the coupling profile.

A further example aspect of the invention relates to a coupling unit for coupling and fastening an energy store. The coupling unit has a coupling side with an electrical plug-in interface for connection to a plug connector at an end side of an energy store, and a terminal panel with a terminal interface for the connection of terminal connectors of electrical components, wherein the plug-in interface and the terminal interface are electrically connected to each other. The coupling unit further has an operating lever, which is pivotable about an axis of rotation, the operating lever including an engagement lever which engages in a coupling profile of an energy store. The axis of rotation is oriented perpendicular to the normal of the coupling side and the engagement lever interacts with the coupling profile of the energy store in such a way that a pivoting movement of the engagement lever is transformed into a translational movement of the energy store in a direction parallel to the normal of the coupling side.

Another example aspect of the invention relates to a system for coupling an energy store to a coupling unit and for connecting the energy store to the coupling unit. The system has the energy store with an end surface on which an electrical plug connector is arranged. The system further includes a normal coupling unit with a coupling side on which a plug-in interface is arranged which is connectable to the plug connector. The system additionally includes an adapter with a fastening portion and a coupling portion with a coupling structure. Particularly, the height of the end surface of the energy store is less than the height of the coupling side of the normal coupling unit. The energy store has a coupling profile arranged in the region of its upper side and in which a lever of a compatible (small) coupling unit is engageable, where the coupling profile is formed from a recess and a coupling cam with an engagement surface, with the coupling profile accommodating the fastening portion of the adapter. The adapter has a coupling structure with a coupling surface and a curved surface. The adapter is detachably fastened to the energy store with its fastening portion, and the normal coupling unit has a lever which engages in the coupling structure of the adapter when the lever pivots such that the pivoting movement is transformed into a translational movement of the energy store that moves the energy store towards the normal coupling unit. The lever engages on the coupling surface of the adapter and is guided on the curved surface of the adapter while pivoting.

Preferred embodiments of the invention are described in the dependent claims. It should be understood that the features mentioned above and which will be explained below can be used not only in the combination stated in each case but also in other combinations or in isolation without going beyond the scope of the present invention.

The adapter according to the invention makes it possible to modify even smaller batteries with a smaller structural height such that they are used in “normal” coupling units which are intended for batteries with a larger structural height. In this way, it is possible, in existing micromobility vehicles, for example in electric bicycles, S-Pedelecs, pedelecs, cargo bikes, etc., to exchange the existing normal energy store and replace it with a smaller energy store with a smaller structural height and correspondingly lower weight. The adapter thus affords a high degree of flexibility in the choice of the cells used. It has proven to be advantageous that the adapter is insertable into the coupling profile of an energy store which is normally used for coupling and fastening the energy store to a compatible coupling unit of a micromobility vehicle.

Because the coupling portion of the adapter has a coupling structure which is suitable for forming a cam mechanism together with the coupling unit, it is possible that a lever for coupling the battery to a coupling unit transforms its pivoting movement into a displacement transverse thereto. In this way, with the adapter according to the invention, the battery thus equipped or the energy store thus equipped is drawn toward the coupling unit. A secure and durable fit and corresponding fixing of the energy store on the coupling unit is ensured. This also ensures that a reliable and durable electrical contact between the energy store and the coupling unit results.

According to a preferred embodiment, the fastening portion of the adapter has a fastening lug which corresponds to a coupling cam of the energy store. The fastening lug is thus fastenable in form-fitting fashion to the coupling cam, which affords advantages for the secure fit and the secure fastening of the adapter on the energy store. At the same time, tilting or an oblique position is avoided by the secure fit. This ensures reliable fastening of the energy store thus equipped to a coupling unit of a micromobility vehicle.

In a further preferred embodiment, the fastening portion has a fastening bore through which a fastener passes. The fastening portion is detachably fastened to the energy store via the fastening bore. The fastener is thus introduced through the fastening bore into a corresponding socket in the energy store and fixed. The fastener is, for example, a screw which is screwed into a corresponding thread in the energy store.

According to another preferred embodiment, the coupling structure has in the coupling portion a coupling surface on which the lever of the coupling unit engages. In this way, displacement of the adapter perpendicular to the coupling surface is effected. The coupling surface is here preferably oriented such that, when the adapter is installed, it is oriented parallel to the end side of the energy store.

According to a preferred embodiment of the adapter, the coupling structure has a curved surface along which the lever of the coupling unit slides when it engages. A force is thus exerted on the coupling surface. The curved surface is thus oriented transversely to the coupling surface and the two surfaces are preferably perpendicular to each other. The curved surface enables the lever to slide along it easily and hence enables assisted guidance when the correspondingly equipped energy store is coupled to the coupling unit.

The energy store according to the invention for supplying a micromobility vehicle with energy has a coupling profile which serves, on the one hand, to couple the energy store to a corresponding retaining device or coupling device of a micromobility vehicle and, on the other hand, the function of the coupling profile is that an adapter, for example the above-described adapter, is couplable to this coupling profile by its fastening portion and fastened thereon in order to use an energy store also for components other than the corresponding retaining devices or coupling units. The coupling profile is designed in such a way that, on the one hand, a lever of a corresponding coupling unit is engageable and, on the other hand, an adapter is accommodated, results in a dual function for the coupling profile. This thus affords multiple options for use of the energy store. There is no need for the provision of any further special sockets for the fastening of an adapter to adapt the smaller energy store to a normal coupling unit for a normal energy store.

According to a preferred embodiment, the coupling profile is formed of a recess on the upper side of the energy store. The recess is defined by a wall and a coupling cam, wherein the coupling cam preferably terminates flush with the end side of the energy store. The coupling profile is designed such that the engagement surface is directed away from the end side. The engagement surface thus corresponds with the coupling portion of the adapter such that the coupling portion of the adapter is retained, preferably in form-fitting fashion, between the engagement surface and the wall. A secure and precise fit of the adapter on the coupling profile of the energy store is enabled as a result.

The coupling unit according to the invention serves to couple an energy store as described above. The coupling unit thus enables fastening and fixing of an energy store with a structural height (and cross-section) which is smaller than that of normal energy stores with a standard structural height (or a standard cross-section). The coupling unit thus allows energy stores such as cells or batteries to be mounted in micromobility vehicles which have only a small structural space available for the mounting of an energy store. This is advantageous, for example, in the case of electric bicycles which have a small frame, such as for example in the case of children's bicycles. The coupling unit affords the advantage that the energy store is coupled to the coupling unit only by its end side and is retained mainly in the region of the end side. Additional retaining elements are providable which engage in a groove of the longitudinal side of the energy store. Nevertheless, the coupling unit enables retention and fastening of an energy store irrespective of its length.

In order to ensure reliable and robust retention of the energy store in the coupling unit, the coupling unit has an engagement lever which engages in a coupling profile of the energy store. The axis of rotation of the engagement lever is oriented perpendicular to the normal of the coupling side of the coupling unit, wherein the coupling side is oriented parallel to the end side of the energy store. The engagement lever forms, together with the corresponding coupling profile of the energy store, a cam mechanism such that the pivoting movement of the engagement lever is transformed into a translational movement of the energy store in a direction parallel to the normal of the coupling side. When the lever is locked, the drawing of the energy store toward the coupling unit is enabled. Opening the lever triggers the pushing of the energy store away from the coupling unit such that the energy store is removed easily.

According to a preferred embodiment of the coupling unit, the engagement lever has a guide surface which comes to bear against an engagement surface of a coupling cam of an energy store when the engagement lever engages on the coupling cam as it pivots. In this way, a force is exerted in the direction of the coupling unit parallel to the normal of the coupling side.

According to a preferred embodiment of the coupling unit, the coupling unit has a retaining rail with retaining elements. The retaining rail extends away from the coupling side of the coupling unit and is preferably oriented perpendicular to the coupling side of the coupling unit. The retaining elements correspond with a retaining groove on a longitudinal side of the energy store and engage in the retaining groove when the energy store is displaced. In this way, the fit and the fastening of the energy store on the extended coupling unit are improved. In addition, the guidance of the energy store is optimized during coupling to the coupling unit and tilting is avoided during the coupling and fixing.

According to a further preferred embodiment, the coupling unit has a securing element which is actively connectable to the operating lever in such a way that twisting or pivoting of the operating lever is prevented. The securing element is movable from a locking position into an unlocking position, wherein the operating lever is released and twisting or pivoting of the operating lever is enabled when the securing element is in the unlocking position. Pivoting of the engagement lever is thus enabled in order to unlock and detach a coupled and fixed energy store.

The system according to the invention for coupling an energy store to the coupling unit has the energy store, an adapter, and a normal coupling unit which is designed to accommodate and fasten normal energy stores (with a greater height than the above-described energy store). The normal coupling unit has a coupling side with a height and/or cross-sectional area which is greater than the height or cross-sectional area of an end surface of the energy store. The energy store is thus not readily fixed and coupled in the normal coupling unit. The energy store is modified by the adapter which is part of the system, where the adapter is fastened on the energy store. A fastening portion of the adapter is inserted and fastened in a coupling profile of the energy store. An energy store modified in such a way allows fixing and coupling to the normal coupling unit, wherein the lever of the normal coupling unit engages into the coupling structure of the adapter when it pivots and thus transforms the pivoting movement of the lever into a translational movement of the energy store equipped with the adapter. The system has the advantage that smaller energy stores which have a smaller cross-sectional height compared with normal energy stores, and are thus lighter, are couplable with normal coupling units. This provides a high degree of flexibility for the user, in particular when it is intended to save weight.

In a preferred embodiment of the system, the lever of the normal coupling unit is pivotable parallel to the coupling side and forms a cam mechanism with the coupling structure of the adapter in order to transform a pivoting movement into a translational movement of the energy store. The lever is thus preferably guided on the curved surfaces of the adapter and engages on a coupling surface such that a force is exerted perpendicular to the coupling surface.

An energy store within the sense of the invention is preferably a battery, a rechargeable battery, or a cell. A micromobility vehicle includes an electric scooter, electric bicycle, pedelec, electric motorcycle, and similar electrically powered vehicles with two wheels, possibly also with a second wheel in the form of a spaced twin wheel. A cam mechanism is one in which a driven movement of a first rotatably mounted cam element results with the aid of a second cam element which is guided in a straight line. The lever of a coupling unit forms the rotatably mounted cam element. The energy store forms the cam element guided in a straight line. The cam mechanism thus transforms continued pivoting of the lever into displacement of the energy store, continued pivoting referring to pivoting of the lever from a position in which the lever comes into engagement with the energy store. The energy store is thus displaced relative to the coupling unit on which the lever is rotatably fastened.

### BRIEF DESCRIPTION OF THE DRAWINGS

The invention will be described and shown in detail below on the basis of some selected exemplary embodiments in conjunction with the attached drawings, in which:

FIG. 1 shows a schematic illustration of a normal coupling unit with three different energy stores;

FIGS. 2a and 2b show an energy store with a small structural height and an adapter;

FIG. 3 shows an energy store with a corresponding coupling unit;

FIGS. 4a-4d show detailed drawings of an energy store and coupling unit during the coupling;

FIGS. 5a and 5b show detailed drawings of an operating lever of the coupling unit;

FIGS. 6a-6c show detailed drawings of a coupling unit with a securing element.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

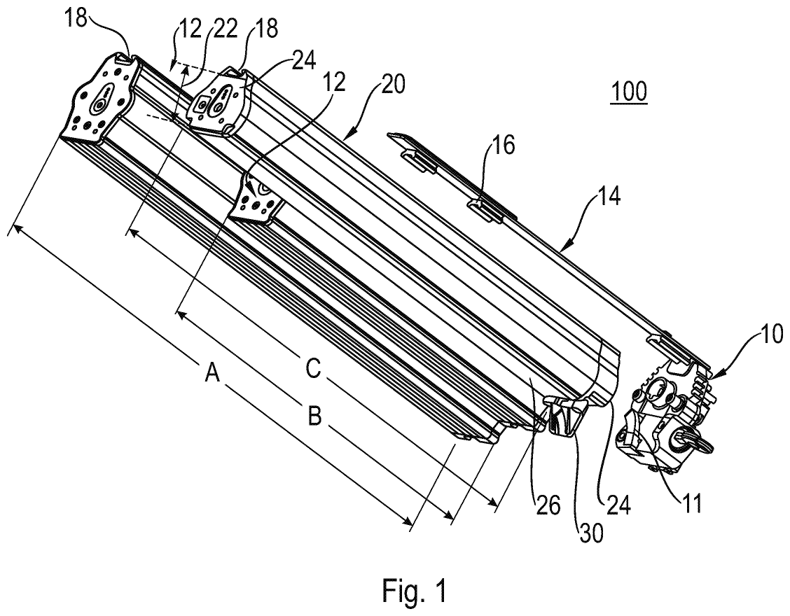

FIG. 1 shows a normal coupling unit 10, with a lever 11, for accommodating and coupling normal energy stores. Two of these normal energy stores 12 with different lengths A and B are shown in FIG. 1. The energy stores 12 are couplable directly to the normal coupling unit 10. For this purpose, the normal coupling unit 10 includes a retaining rail 14 with retaining elements 16, which rail 14 is engageable in a retaining groove 18 on a longitudinal side of the normal energy stores 12.

FIG. 1 also shows an energy store 20 with a length C, the structural height of which is considerably smaller than the structural height of the normal energy stores 12. A height 22 of the energy store 20, measured at an end side 24, is less than the corresponding height of the normal energy stores 12. For this reason, the energy store 20 is not readily coupled and fastened to the normal coupling unit 10.

Also shown in FIG. 1 is that the energy store 20 is provided with an adapter 30 which is arranged on an upper side 26 close to another end side 24.

The normal coupling unit 10 and the energy store 20 with the fastened adapter 30 form a system 100 which allows even small energy stores 20 with a small height 22 to be fastened in a normal coupling unit 10. The energy store 20, which is a battery, is thus lockable in the normal coupling unit 10 even though the height of the energy store is smaller.

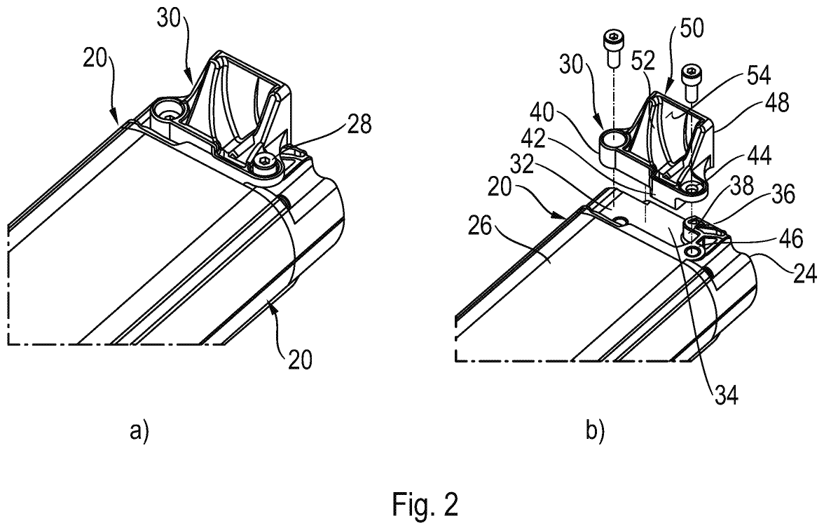

FIGS. 2a and 2b show a part of the energy store 20 with the adapter 30. In FIG. 2a, the adapter 30 is fastened to the energy store 20, wherein it is screwed on with fastening elements 28 in the form of screws.

As best shown in FIG. 2b, the energy store 20 has on its upper side 26, close to the end side 24, a recess 32 which forms a coupling profile 34 with a coupling cam 36. The coupling cam 36 has an engagement surface 38 on which a lever of a compatible coupling unit engages in order to fasten and fix the energy store 20, without the adapter, in the compatible coupling unit.

The adapter 30 has a fastening portion 40 with a fastening lug 42 which fit into the coupling profile 34 in a form-fitting fashion. When the adapter 30 is inserted with the fastening portion 40 in the coupling profile 34 of the energy store 20, the fastening elements 28 are then screwed through fastening bores 44 into threaded sockets 46 on the energy store 20 in order to fix the adapter 30 in place. A coupling portion 48 has a coupling structure 50, open at the top, into which a lever of a normal coupling unit 10 is engageable. Such lever is guided on at least one of the (arched) curved surfaces 52 whilst it engages in the coupling structure 50 in order thus to exert a force on a coupling surface 54 and to move the adapter 30, together with the energy store 20, in the direction of the normal coupling unit 10.

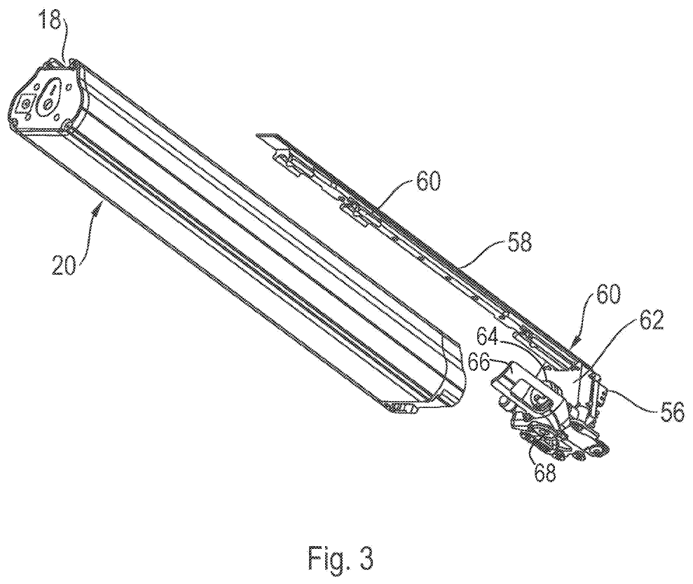

FIG. 3 shows the energy store 20 with a small structural height and a compatible coupling unit 56 with an integrally formed retaining rail 58 with retaining elements 60 which engage in a retaining groove 18 of the energy store 20.

The coupling unit 56 has a coupling side 62 with a plug-in interface 64 which establishes an electrical connection between the energy store 20 and electrical components of the micromobility vehicle, which components are connectable on the rear side of the coupling unit 56.

An operating lever 66 is rotatable about an axis of rotation 68 in order to enable coupling of the energy store 20 to the coupling unit 56 and to detachably fix the energy store 20 to the coupling unit 56.

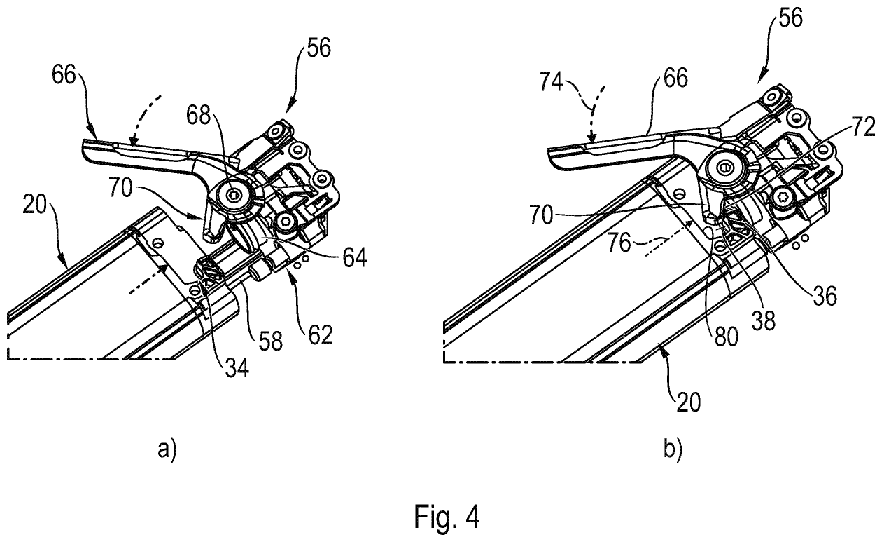

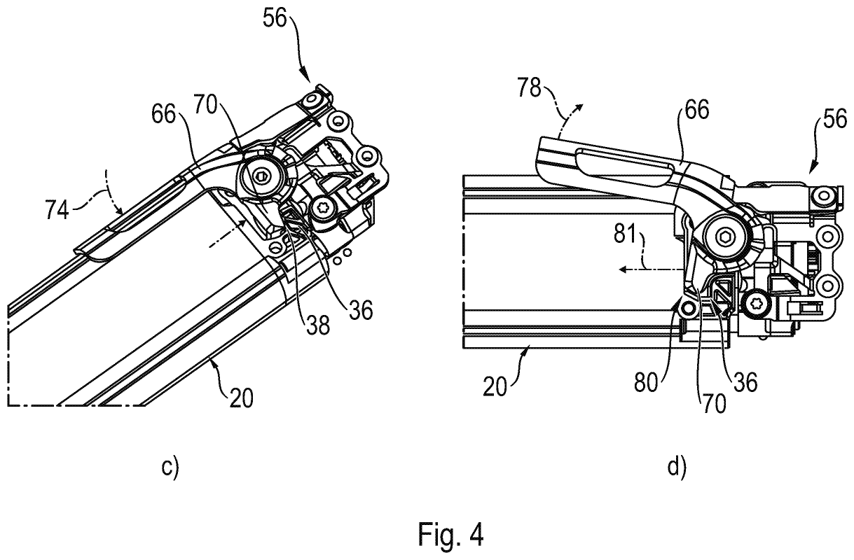

FIGS. 4a-4c show the procedure of fastening the energy store 20 on the coupling unit 56 in different steps.

FIG. 4a shows the coupling unit 56 with its coupling side 62 and the plug-in interface 64 fastened thereon on the coupling unit 56, and a retaining rail 58 of the coupling unit 56 on which the energy store 20 is moved. The operating lever 66 which is pivotable about the axis of rotation 68 includes an engagement lever 70 for engaging in the coupling profile 34 of the energy store 20. Whereas FIG. 4a shows the energy store 20 spaced apart from the coupling unit 56, the manner in which the engagement lever 70 engages with its guide surface 72 on the engagement surface 38 of the coupling cam 36 is illustrated in FIG. 4b. The movement of the operating lever 66 in the direction of the arrow 74 in FIG. 4b effects a translational movement of the energy store 20 in the direction of the arrow 76 and thus parallel to the normal of the coupling side 62 (FIG. 4a) such that the energy store 20 is drawn toward the coupling unit 56.

The complete pivoting of the operating lever 66 is shown in FIG. 4c, in the end position of which the engagement lever 70 bears completely against the engagement surface 38 and has drawn the energy store 20 toward the coupling unit 56. The energy store 20 now bears with its end side against the coupling side 62 (FIG. 4a) of the coupling unit 56, and the energy store 20 is fastened and fixed on the coupling unit 56.

An electrical connection of the energy store 20 to the plug-in interface 64 is thus established such that electrical components of the micromobility vehicle are electrically connected to the energy store 20.

FIG. 4d shows the procedure of detaching the energy store 20 from the coupling unit 56. The operating lever 66 is moved in the direction of the arrow 78, wherein the engagement lever 70 bears against a wall 80 of the coupling profile 34 and pushes the energy store 20 away from the coupling unit 56 in the direction of the arrow 81. Simple removal of the energy store 20 by the user is ensured by such detachment and translational movement of the energy store 20.

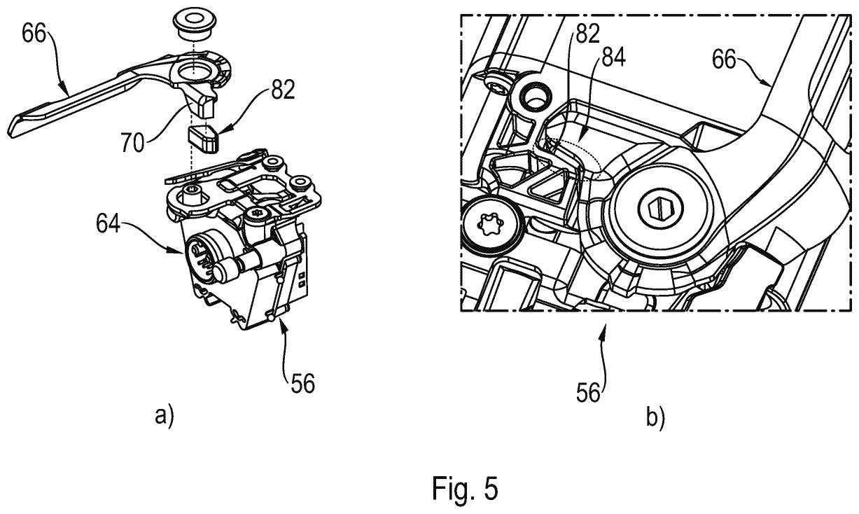

FIGS. 5a and 5b show the lever mechanism of the coupling unit 56 in detail. The operating lever 66 includes a pretensioning element 82 arranged on its engagement lever 70 in order to ensure that any manufacturing, mounting, or other tolerances in the end position of the energy store 20 are compensated when the energy store 20 is fastened on the coupling unit 56. The pretensioning element 82 is preferably elastic, for example a rubber pretensioning element. A defined oversize 84 of the pretensioning element 82 ensures that the tolerances are compensated, as a result of which the pretensioning relative to the energy store 20 is generated. A firm and tight fit of the energy store on the plug-in interface 64 and in the coupling unit 56 is thus ensured.

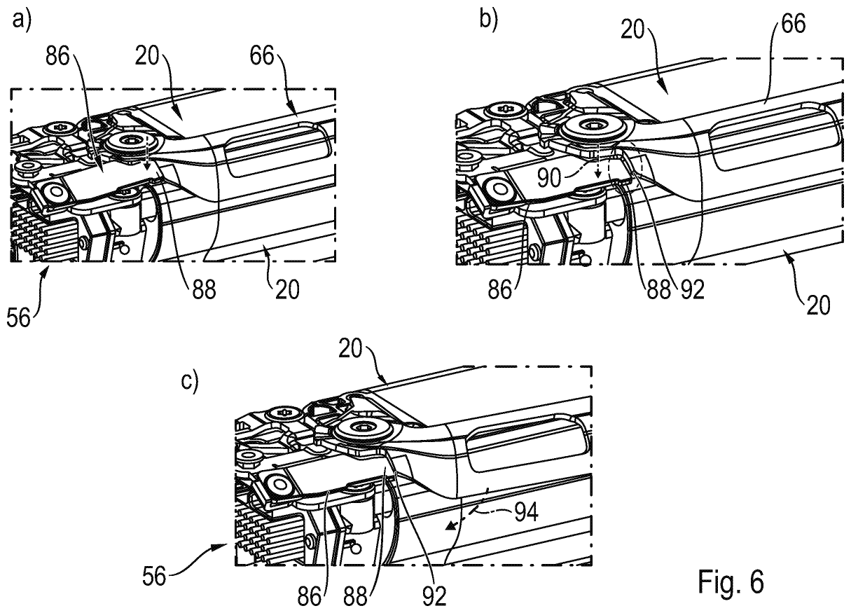

FIGS. 6a-6c each show a detailed view of the coupling unit 56 with the fastened energy store 20.

A securing element 86 is arranged on the coupling unit 56 such that it is actively contactable with the operating lever 66 to prevent movement of the operating lever 66. The elongated securing element 86 is connected at one end to the coupling unit 56 by a screw, whilst a free end 88 has an end side which is in contact with and substantially flush with a longitudinal surface of the operating lever 66 in FIG. 6a. The securing element 86 is movable in such a way that the free end 88 is pushable in the direction of the arrow 90 toward the coupling unit 56, as a result of which the end side of the free end 88 disengages from the operating lever, as shown in detail in FIG. 6b.

Once the securing element 86 has been pushed so far in the direction of the coupling unit 56 that the free end 88 of the securing element 86 is moved below the operating lever 66 and exposes a narrow side 92 of the operating lever 66, as shown in FIG. 6c, an unlocking position has been reached. In this unlocking position, the operating lever 66 is released and pivoting of the operating lever 66 in the direction of the arrow 94 is possible such that the energy store 20 is detachable from the coupling unit 56 and removed.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE SIGNS

10 normal coupling unit
11 lever
12 normal energy store
14 retaining rail
16 retaining element
18 retaining groove
20 energy store
22 height
24 end side
26 upper side
28 fastening element
30 adapter
32 recess
34 coupling profile
36 coupling cam
38 engagement surface
40 fastening portion
42 fastening lug
44 fastening bore
46 threaded socket
48 coupling portion
50 coupling structure
52 curved surface
54 coupling surface
56 coupling unit
58 retaining rail
60 retaining element
62 coupling side
64 plug-in interface
66 operating lever
68 axis of rotation
70 engagement lever
72 guide surface
74 direction of arrow
76 direction of arrow
78 direction of arrow
80 wall
81 direction of arrow
82 pretensioning element
84 oversize
86 securing element
88 free end
90 direction of arrow
92 narrow side
94 direction of arrow
100 system

1-13: (canceled)

14. An adapter for fastening to an energy store (20) of a micromobility vehicle and for coupling the energy store (20) to a coupling unit, the adapter comprising:
a fastening portion (40) fastenable to a socket of the energy store (20); and
a coupling portion (48) having a coupling structure (50), the coupling structure (50) forming a cam mechanism with a lever (11) of the coupling unit where pivoting of the lever (11) is converted by engagement into the coupling structure (50) into a displacement in a direction transverse to a direction of pivoting of the lever (11).

15. The adapter of claim 14, wherein the fastening portion (40) has a fastening lug (42) fastenable by form-fitting to a coupling cam (36) of the energy store (20).

16. The adapter of claim 14, wherein the fastening portion (40) has a fastening bore (44) for receiving a fastener for detachable fastening of the fastening portion (40) to the energy store (20).

17. The adapter of claim 14, wherein the coupling structure (50) has a coupling surface (54) on which the lever of the coupling unit engages to displace the adapter (30) in a direction perpendicular to the coupling surface (54).

18. The adapter of claim 17, wherein the coupling structure (50) has a curved surface (52) along which the lever of the coupling unit slides to apply a force on the coupling surface (54), the curved surface (52) being transverse to the coupling surface (54).

19. An energy store for supplying a micromobility vehicle with energy, the energy store comprising:
an electric plug connector on an end side (24) of the energy store (20) for connecting to a coupling unit (56); and
a coupling profile (34) defined at an upper side (26) of the energy store, the coupling profile (34) including a coupling cam (36) with an engagement surface (38), the engagement surface (38) being contactable by a lever of a coupling unit (56) engageable in the coupling profile (34) such that a pivoting movement of the lever is converted into a displacement of the energy store (20) in a direction normal to the end side (24) of the energy store (20), the coupling profile (34) allowing detachable fastening of an adapter (30) for adapting the energy store (20) for coupling to a normal coupling unit (10) for normal energy stores (12) with a greater height than the energy store (20).

20. The energy store of claim 19, wherein the coupling profile (34) is defined by a recess (32) on the upper side (26) of the energy store (20), the recess defining a wall (80) and the coupling cam (36), the coupling cam (36) terminating flush with the end side (24), the engagement surface (38) facing away from the end side (24), a coupling portion (48) of an adapter (30) being retainable by form-fitting between the engagement surface (38) and the wall (80).

21. A coupling unit for coupling and fastening an energy store (20), the coupling unit comprising:
an electrical plug-in interface (64) on a coupling side (62) of the coupling unit for connection to a plug connector at an end side (24) of an energy store (20);
a terminal panel with a terminal interface for the connection of terminal connectors of electrical components, the terminal interface being electrically connected to the electrical plug-in interface (64); and
an operating lever (66) pivotable about an axis of rotation (68), the axis of rotation (68) being perpendicular to a normal of the coupling side (62) of the coupling unit and to an engagement lever (70) defined by the operating lever (66), the engagement lever (70) being engageable in a coupling profile (34) of an energy store (20) such that pivoting movement of the engagement lever (70) is transformed into a translational movement of the energy store (20) in a direction parallel to the normal of the coupling side (62) of the coupling unit.

22. The coupling unit of claim 21, wherein the engagement lever (70) has a guide surface (72) which contacts an engagement surface (38) of a coupling cam (36) of an energy store (20) when the engagement lever (70) pivots such that a force is exerted on the coupling unit (56) in the direction parallel to the normal of the coupling side (62) of the coupling unit.

23. The coupling unit of claim 21, wherein the coupling unit (56) has a retaining rail (58) with retaining elements (60), the retaining rail (58) extending away from the coupling side (62) of the coupling unit, the retaining elements (60) corresponding with and engageable in a retaining groove (18) defined in a longitudinal side of the energy store (20) when the energy store (20) is displaced.

24. The coupling unit of claim 21, further comprising a securing element (86), the securing element (86) preventing pivoting of the operating lever (66) when contacting the operating lever (66), the securing element (86) being movable into an unlocking position in which the operating lever (66) is released from the securing element (86) and enabled to pivot about the axis of rotation (68) of the operating lever (66).

25. A system for coupling an energy store (20) to a coupling unit, the system comprising:
an energy store (20) having an electrical plug connector on an end side (24), an upper side of the energy store (20) defining a coupling profile (34), the coupling profile (34) being defined by a recess (32) in the upper side and a coupling cam (36) having an engagement surface (38);
a normal coupling unit (10) having a plug-in interface (64) on a coupling side and a lever (110), the plug-in interface (64) being connectable to the electrical plug connector, the lever (110) being pivotable about a pivot axis, a height of the coupling side being greater than a height (22) of the end side (24) of the energy store (20); and
an adapter (30) with a fastening portion (40) and a coupling portion (48), the fastening portion (40) of the adapter (30) being receivable within the coupling profile (34) of the energy store (20), the fastening portion (40) of the adapter (30) being detachably fastened to the energy store (20), the coupling portion (48) of the adapter (30) having a coupling structure (50) with a coupling surface (54) and a curved surface (52), the lever (11) of the normal coupling unit (10) engages on the coupling surface (54) of the adapter (30) and is guided on the curved surface (52) of the adapter (30) such that pivoting of the lever (11) is transformed into a translational movement of the energy store (20) towards the normal coupling unit (10).

26. The system of claim 25, wherein the lever (11) of the normal coupling unit (10) is pivotable parallel to the coupling side, and
wherein the lever (11) and the coupling structure (50) together form a cam mechanism for transforming the pivoting of the lever (11) into the translational movement of the energy store (20).

27. The system of claim 25, wherein the fastening portion (40) of the adapter (30) has a fastening lug (42) fastenable by form-fitting to the coupling cam (36) of the energy store (20).

28. The system of claim 25, wherein the fastening portion (40) of the adapter (30) has a fastening bore (44) for receiving a fastener for detachable fastening of the fastening portion (40) to the energy store (20).

29. The system of claim 25, wherein the curved surface (52) is transverse to the coupling surface (54).

30. The system of claim 25, wherein the recess (32) defines a wall (80) and the coupling cam (36) having the engagement surface (38), the coupling cam (36) terminating flush with the end side (24) of the energy store (20), the engagement surface (38) facing away from the end side (24) of the energy store (20), the coupling portion (48) of the adapter (30) being retainable by form-fitting between the engagement surface (38) and the wall (80).

31. The system of claim 25, further comprising a compatible coupling unit (56), the compatible coupling unit (56) comprising:
an electrical plug-in interface (64) on a coupling side (62) of the compatible coupling unit (56) for connection to the electrical plug connector at the end side (24) of an energy store (20); and
an operating lever (66) pivotable about an axis of rotation (68), the axis of rotation (68) of the operating lever (66) being perpendicular to a normal of the coupling side (62) of the compatible coupling unit (56) and to an engagement lever (70) defined by the operating lever (66), the engagement lever (70) being engageable in the coupling profile (34) of the energy store (20) such that pivoting movement of the engagement lever (70) is transformed into translational movement of the energy store (20) in a direction parallel to the normal of the coupling side (62) of the compatible coupling unit (56).

32. The system of claim 31, wherein the engagement lever (70) has a guide surface (72) which contacts the engagement surface (38) of the coupling cam (36) of the energy store (20) when the engagement lever (70) pivots such that a force is exerted on the compatible coupling unit (56) in the direction parallel to the normal of the coupling side (62) of the compatible coupling unit (56).

33. The system of claim 31, wherein the compatible coupling unit (56) further includes a securing element (86), the securing element (86) preventing pivoting of the operating lever (66) when contacting the operating lever (66), the securing element (86) being movable into an unlocking position in which the operating lever (66) is released from the securing element (86) and enabled to pivot about the axis of rotation (68) of the operating lever (66).
